(19) United States
(12) Patent Application Publication
(10) Pub. No.: US 2026/0005528 A1
(43) Pub. Date: Jan. 1, 2026

(54) DISPLAY STAND CAPABLE OF BEING CHARGED USING POGO PIN COUPLING

(71) Applicant: TORDER CO., LTD., Seoul (KR)

(72) Inventor: Jeong Jin LEE, Seoul (KR)

(21) Appl. No.: 19/236,351

(22) Filed: Jun. 12, 2025

(30) Foreign Application Priority Data
Jun. 28, 2024 (KR) 10-2024-0085040

(51) Int. Cl. H02J 7/00

(52) U.S. Cl. CPC H02J 7/0044; H02J 7/0063

(57) ABSTRACT

A display stand may include a sliding body having a planar shape in a longitudinal direction, a battery holder coupled to a preset position of the sliding body, having a hexahedral shape including an upper surface and open two faces facing each other, and including a space which corresponds to a size of a battery and in which a battery is mounted, a mounting bracket including a display coupling unit installed at one end of the sliding body and configured to rotate right and left by a preset angle, a display mounting module coupled to the display coupling unit in a sliding manner and having a display mounted on the display mounting module, and a coupling assembly including an upper support and a lower support at another end of the sliding body such that the display stand is mounted on an object.

### CROSS-REFERENCE TO RELATED APPLICATION

This application is based on and claims priority under 35 U.S.C. § 119 to Korean Patent Application No. 10-2024-0085040, filed on Jun. 28, 2024, in the Korean Intellectual Property Office, the disclosure of which is incorporated by reference herein in its entirety.

### BACKGROUND

### 1. Field

The present disclosure relates to a display stand capable of being charged using a pogo pin coupling, and more specifically, to a display stand that supplies power to a display from a commercial power source or a battery using a pogo pin coupling.

### 2. Description of the Related Art

Due to an increase in labor cost, most restaurants are using stationary-type ordering devices. A stationary-type ordering device may be installed in a store or on a table.

The stationary-type ordering device may be powered by a power source or by connecting a battery.

Conventionally, most stationary-type ordering devices are powered, but there is a problem that it is difficult for the stationary-type ordering devices to be applied to external tables, and when cleaning the stationary-type ordering devices, cables have to be removed and recoupled one by one. In order to solve the problem, a battery may be connected to the stationary-type ordering device to apply the stationary-type ordering device to external tables, but the heat generated from the battery may be transferred to the stationary-type ordering devices which may cause another problem in the stationary-type ordering device.

Accordingly, there is a need for a display stand that supplies power to a display from a commercial power source or battery using a pogo pin coupling.

### SUMMARY

The present disclosure provides a display stand that supplies power to a display from a commercial power source or a battery using a pogo pin coupling.

Technical problems to be solved by embodiments are not limited to the technical problem described above, and there may be other technical problems.

According to an aspect of the present disclosure, the present disclosure provides a display stand that may be charged using a pogo pin coupling. The display stand includes a sliding body having a planar shape in a longitudinal direction, a battery holder coupled to a preset position of the sliding body, having a hexahedral shape including an upper surface and open two faces facing each other, and including a space which corresponds to a size of a battery and in which a battery is mounted, a mounting bracket including a display coupling unit installed at one end of the sliding body and configured to rotate right and left by a preset angle, a display mounting module coupled to the display coupling unit in a sliding manner and having a display mounted on the display mounting module, and a coupling assembly including an upper support and a lower support at another end of the sliding body such that the display stand is mounted on an object, wherein a coupling height is adjusted through a double screw structure of the lower support.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1 to 3 are views illustrating a display stand, which may be charged using a pogo pin coupling, according to an embodiment of the present disclosure;

FIGS. 4 to 10A, 10B, and 10C are view illustrating a coupling assembly of a display stand, which may be charged using a pogo pin coupling, according to an embodiment of the present disclosure;

FIG. 11 is a view illustrating an embodiment of a display stand, which may be charged using a pogo pin coupling, according to an embodiment of the present disclosure;

FIG. 12 is a view illustrating a battery holder of a display stand, which may be charged using a pogo pin coupling, according to an embodiment of the present disclosure; and

FIG. 13 is a view illustrating an embodiment in which a battery holder is applied to a display stand, which may be charged using a pogo pin coupling, according to an embodiment of the present disclosure.

### DETAILED DESCRIPTION

Hereafter, the present disclosure will be described in detail with reference to the accompanying drawings. However, the present disclosure may be implemented in many different forms and is not limited to the embodiments described herein. Also, the accompanying drawings are only for easy understanding of the embodiments disclosed in the present specification, and the technical ideas disclosed in the present specification are not limited by the accompanying drawings. All terms, including technical and scientific terms, used herein should be interpreted as having the meaning generally understood by those skilled in the art to which the present disclosure belongs. Terms defined in the dictionary should be interpreted as having additional meanings consistent with the relevant technical literature and the present disclosure, and should not be interpreted in a very ideal or restrictive sense unless otherwise defined.

In order to clearly describe the present disclosure in the drawings, parts irrelevant to the descriptions are omitted, and a size, a shape, and a form of each component illustrated in the drawings may be variously modified. The same or similar reference numerals are assigned to the same or similar portions throughout the specification.

Throughout the specification, when a portion is said to be “connected (coupled, in contact with, or combined)” with another portion, this includes not only a case where it is “directly connected (coupled, in contact with, or combined)”, but also a case where there is another member therebetween. Also, when a portion “includes (comprises or provides)” a certain component, this does not exclude other components, and means to “include (comprise or provide)” other components unless otherwise described.

In the present disclosure, a “portion” includes a unit realized by hardware, a unit realized by software, and a unit realized by using both. In addition, one unit may be realized by using two or more pieces of hardware, and two or more units may be realized by using one piece of hardware. Meanwhile, a “˜ portion” is not limited to software or hardware, and a “˜ portion” may be configured to be included in an addressable storage medium or may be configured to reproduce one or more processors. Therefore, in one example, “˜ portion” refers to components, such as software components, object-oriented software components, class components, and task components, and includes processes, functions, properties, and procedures, subroutines, segments of program code, drivers, firmware, microcode, circuits, data, databases, data structures, tables, arrays, and variables. The functions provided within the components and “portions” may be combined into a smaller number of components and “portions” or may be further separated into additional components and “portions”. Additionally, components and “portions” may be implemented to regenerate one or more central processing units (CPUs) included in a device or security multimedia card.

Suffixes “module” and “unit” for the components used in the following description are given or used interchangeably in consideration of ease of writing the specification, and do not have meanings or roles that are distinguished from each other by themselves. Also, in describing the embodiments disclosed in the present specification, when it is determined that a detailed descriptions of related known technologies may obscure the gist of the embodiments disclosed in the present specification, the detailed descriptions are omitted.

Terms indicating ordinal numbers, such as first and second, used in the present specification are used only for the purpose of distinguishing one component from another component and do not limit the order or relationship of the components. For example, the first component of the present disclosure may be referred to as the second component, and similarly, the second element may also be referred to as the first component. The singular forms used in the present specification should be construed to include the plural forms as well, unless the opposite is clearly indicated.

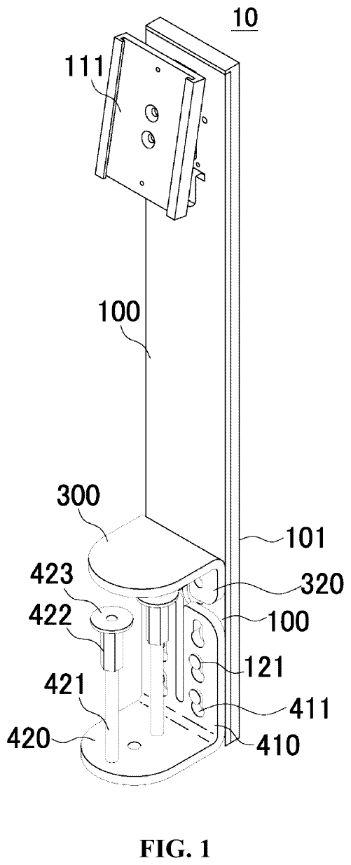

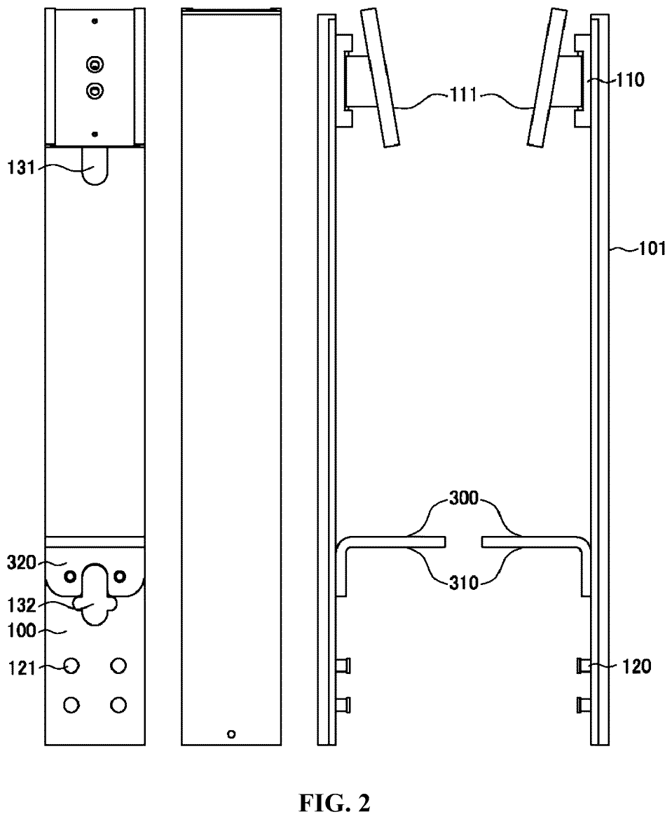

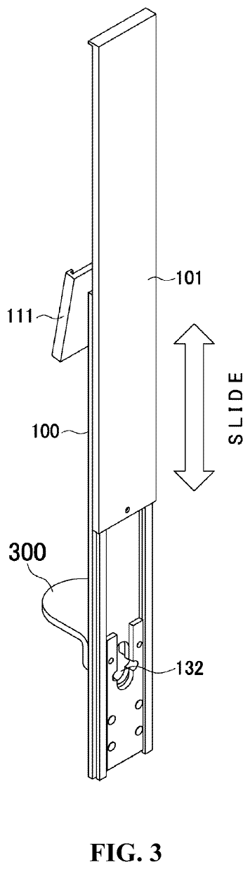

FIGS. 1 to 3 are views illustrating a display stand, which may be charged using a pogo pin coupling, according to an embodiment of the present disclosure.

In the present specification, the display stand may be referred to as a mounting device 10.

Referring to FIGS. 1 to 3, the mounting device 10 of the present disclosure includes a sliding body 100, a sliding cover 101, a stand bracket 110, a display coupling unit 111, a protrusion 120, a protrusion head 121, an upper cable inlet 131, a lower cable inlet 132, an upper support 300, and a lower support 400. In this case, the upper support 300 and the lower support 400 may be referred to as a coupling assembly.

The sliding body 100 may be configured in a planar shape in a longitudinal direction. The sliding cover 101 may be configured to open and close by sliding in the longitudinal direction on the rear of the sliding body 100. An internal space is formed between the sliding body 100 and the sliding cover 101 through which a cable passes, and the cable passing through the internal space is prevented from being exposed to the outside.

The mounting bracket 110 may be configured at one end of the sliding body 100 to include a display coupling unit 111 and may be configured to rotate left and right by a preset angle. The display coupling unit 111 may be configured to be coupled with a display mounting module 500 on which a display is mounted. In this case, the display coupling unit 111 may be coupled with the display mounting module 500 in a sliding manner. In addition, the display mounting module 500 may include a charging port that receives power from the outside. The display mounting module 500 may include a wireless charging module. A heat sink may be included between the wireless charging module and the display, and the heat sink may prevent the heat generated during wireless charging from being transferred to the inside of the display. Here, the display may be a communicable computing terminal device, such as a tablet or a smartphone.

Although not illustrated in the drawings, the display coupling unit 111 and the display mounting module 500 may be coupled with each other by a configuration including a male pogo pin and a female pogo pin to supply and receive power. In this case, a pogo pin included in the display coupling unit 111 may receive power from a battery of a battery holder or a commercial power source, and may supply power to a pogo pin included in the display mounting module 500. The male pogo pin and the female pogo pin may each include a magnet with magnetism therein, and a positive pole (+pole) and a negative pole (−pole) may be connected to each other by magnetic force.

The protrusion 120 is formed on the sliding body 100, and may be coupled with a groove 411 formed on the lower support 400 described below. In this case, the protrusion 120 may have the protrusion head 121 formed at the end to have a greater area than the protrusion 120 so as not to be separated when no physical force is applied to the coupled groove 411.

The upper cable inlet 131 and the lower cable inlet 132 are formed respectively at an upper portion and a lower portion in a longitudinal direction of the sliding body 100, and a cable may pass through the upper cable inlet 131, the lower cable inlet 132, and a space between the sliding body 100 and a slide cover to supply power to the battery or the display.

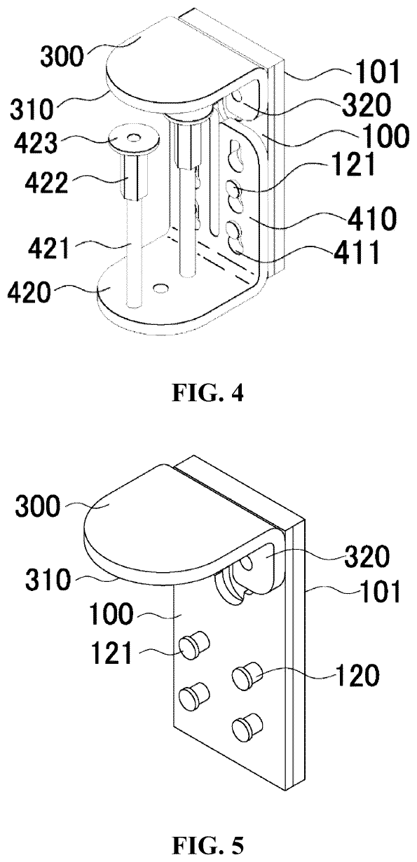

A coupling assembly including the upper support 300 and the lower support 400 may be coupled to the sliding body 100 such that the mounting device 10 is mounted on an object. In this case, a coupling height may be adjusted through coupling positions of multiple protrusions 120 formed on the sliding body 100 and multiple grooves 411 formed on the lower support 400. Also, the coupling height may be adjusted through a double screw structure of the lower support 400. Descriptions of the coupling assembly are made below with reference to FIGS. 4 to 10.

In an additional embodiment of the present disclosure, the sliding body 100 may further include a rotary cover in which multiple hinges are formed in a longitudinal direction and which rotates in a direction of the multiple hinges to be opened or closed. The configuration allows a cover to be opened or closed in a low-ceilinged area.

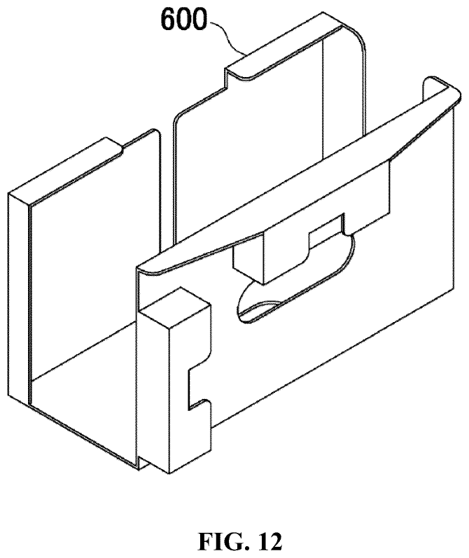

Although not illustrated in the drawings, the mounting device 10 may further include a card reader coupling unit and a battery holder 600. The card reader coupling unit may be configured to be adjacent to the mounting bracket 110 on the sliding body 100 so as to be coupled with a card reader. The battery holder 600 is described below with reference to FIG. 12.

FIGS. 4 to 10 are view illustrating a coupling assembly of a display stand, which may be charged using a pogo pin coupling, according to an embodiment of the present disclosure.

Referring to FIG. 4, the coupling assembly having a double screw structure of the present disclosure includes the sliding body 100, the upper support 300, and the lower support 400. The sliding body 100 may include the multiple protrusions 120 formed on an inner surface. The upper support 300 and the lower support 400 may each have multiple surfaces. However, configurations of the upper support 300 and the lower support 400 are not limited thereto.

The upper support 300 may include an upper horizontal support 310 formed in a horizontal plate shape to be fixed in close contact with an upper surface of an object on which the coupling assembly is mounted, and an upper vertical support 320 formed in a plate shape in a direction perpendicular to the upper horizontal support 310 so as to be partially overlap and be coupled with the sliding body 100.

The lower support 400 may include a lower vertical support 410 that has a plate shape in a vertical direction and has the multiple grooves 411 coupled to the multiple protrusions 120, and a lower horizontal support 420 formed in a plate shape in a direction vertically upward from the lower vertical support 410 and including multiple first height adjustment screws 421 coupled to the lower horizontal support 420.

In addition, the multiple grooves 411 may each have a shape that narrows in a certain direction such that the multiple protrusions 120 are hooked and coupled with the multiple grooves 411, and the multiple first height adjustment screws 421 may be coupled respectively with multiple second height adjustment screws 422 configured to be in close contact with the coupling assembly in a lower surface of an object.

Referring to FIG. 5, the upper support 300 may have a shape of “┐”. However, the shape of the upper support 300 is not limited thereto.

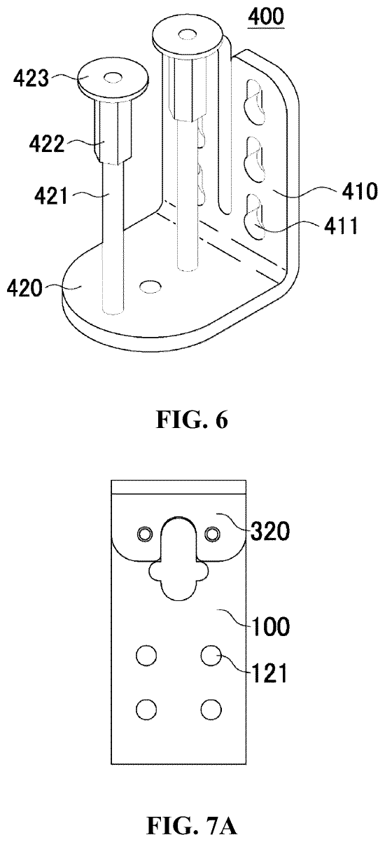

In order to have the frictional force described while describing the upper support 300 in FIG. 4, a first frictional portion having a certain frictional force may be formed on a lower surface of the upper horizontal support 310 configured in the horizontal direction of the upper support 300. In this case, the first frictional portion may be formed by directly processing the upper horizontal support 310 or may be attached to a separate surface material, such as a non-woven fabric. Referring to FIG. 6, the lower support 400 may have a shape of “└”. Alternatively, although not illustrated in the drawings, the lower support 400 may have a shape of an “├”. However, the shape of the lower support 400 is not limited thereto.

In a case where the lower support 400 has a shape of “L”, the multiple grooves 411 coupled respectively with the multiple protrusion 120 of the sliding body 100 may be formed in the lower vertical support 410 configured in the vertical direction of the lower support 400, and multiple holes are formed through which the multiple first height adjustment screws 421 are coupled with the lower horizontal support 420 configured in the horizontal direction of the lower support 400.

In addition, the multiple grooves 411 may have forms that are narrowed in the longitudinal direction such that the multiple protrusions 120 are caught. In addition, the multiple first height adjustment screws 421 may be coupled respectively with the multiple second height adjustment screws 422 each having a shape that has frictional force such that the mounting device 10 is in close contact with a lower surface of an object. The second height adjustment screw 422 has a wider diameter than the first height adjustment screw 421 to have the frictional force described above because of being in close contact with a lower surface of an object, and a separate surface material, such as non-woven fabric, may be attached to the second height adjustment screw 422. Also, a region of the second height adjustment screw 422 which comes into contact with a lower surface of an object may be configured in a shape of the second height adjustment screw head 423 having a greater surface area to maximize frictional force.

In addition, although not illustrated in the drawings, when the lower support 400 has a shape of “├”, the lower support 400 may further include an extended lower vertical support 410 extending in a direction of the lower vertical support 410 from a position where the lower vertical support 410 meets the lower horizontal support 420, and another groove 411 may be formed in the extended lower vertical support 410 in a direction symmetrical to the groove 411 of the lower vertical support 410 based on the lower horizontal support 420.

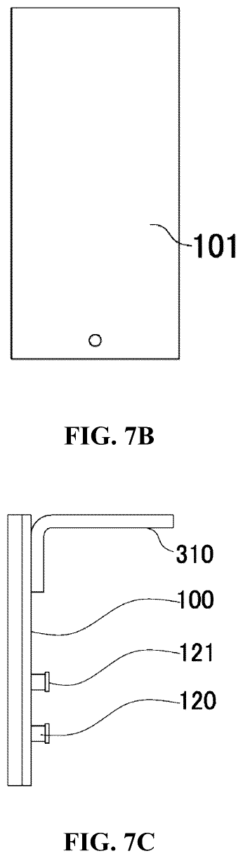

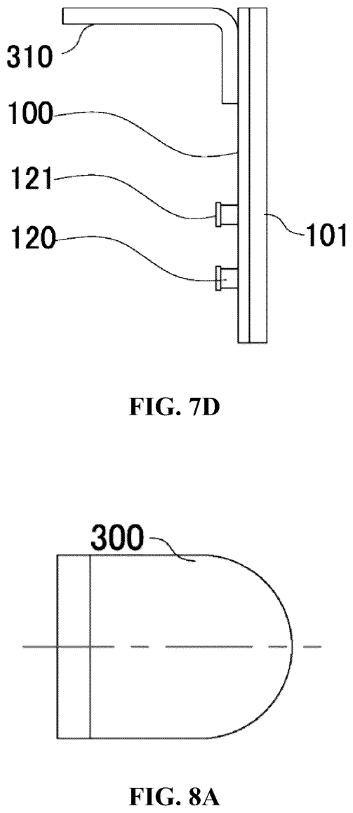

A to D of FIG. 7 respectively illustrate a front view, a rear view, a left side view, and a right side view of the upper support 300. Referring to the front view of the upper support 300 illustrated in A of FIG. 7, the upper support 300 may include the upper horizontal support 310 and the upper vertical support 320 perpendicular to the upper horizontal support 310. In addition, the upper vertical support 320 may be coupled with the sliding body 100. Referring to the back view of the upper support 300 illustrated in B of FIG. 7, the back of the upper support 300 may be configured with the sliding cover 101. A cable or wire may pass through a space between the sliding body 100 and the sliding cover 101 to provide video, power, and communication. Referring to the left side view and the right side view of the upper support 300 respectively illustrated in C and D of FIG. 7, the protrusion 120 of the sliding body 100 may have the protrusion head 121 formed at the end to have a greater diameter than the protrusion 120 so as to be coupled with the lower support 400 and is not separated from the lower support 400

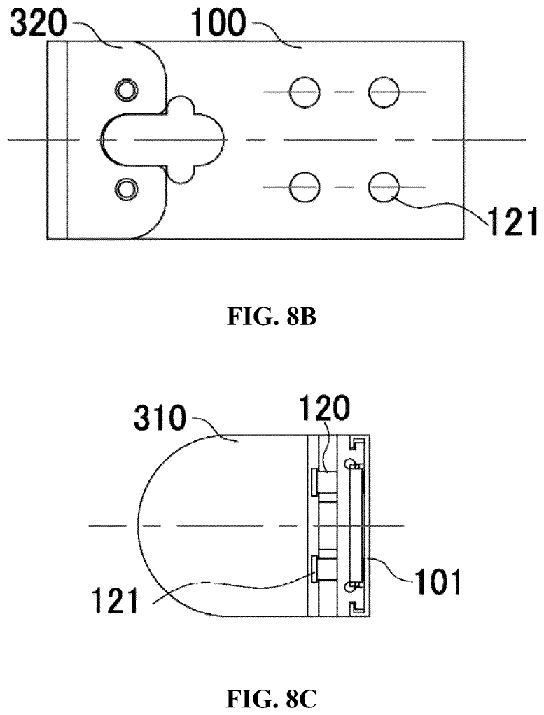

A to C of FIG. 8 respectively illustrate a plan view, a front view, and a bottom view of the upper support 300. Referring to the plan view of the upper support 300 illustrated in A of FIG. 8, an upper portion has a flat surface, and the descriptions made with reference to FIG. 7 may be used for descriptions of the front view. Referring to the bottom view of the upper support 300, the bottom of the upper support 300 may have a structure of the sliding cover 101 configured on a back surface of the sliding body 100, as illustrated in C of FIG. 5. The sliding cover 101 has a rail on an edge, and may be opened or closed by moving along a rail of the sliding body 100 corresponding to the rail of the sliding cover 101. However, the structure of the sliding cover 101 is not limited thereto.

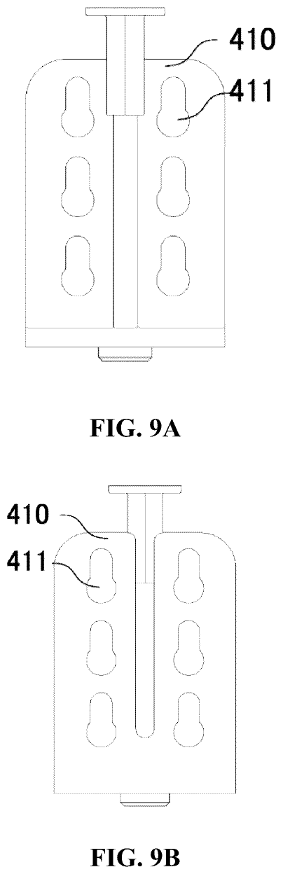

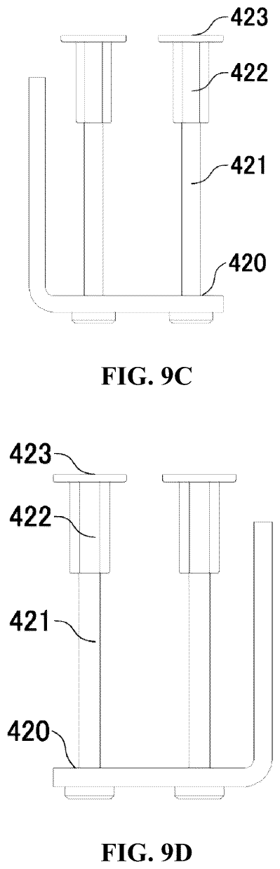

A to D of FIG. 9 respectively illustrate a front view, a back view, a left side view, and a right side view of the lower support 400. Referring to the front view and the back view of the lower support 400 illustrated in A and B of FIG. 9, the groove 411 that is coupled with the upper support 300 may be formed in the lower vertical support 410 configured in the longitudinal direction of the lower support 400. In this case, the groove 411 includes a pair of grooves formed in parallel, and the pair of grooves are formed in multiple pieces in a vertical direction on the lower vertical support 410, and the protrusion 120 includes a pair projections formed in parallel, and the pair of projections are formed in multiple pieces in the vertical direction on the sliding body 100, and the first heights of the upper horizontal support 310 and the lower horizontal support 420 may be adjusted through the coupling of the pair of grooves and the pair of projections.

In addition, the first height adjustment screw 421 may be coupled with the lower horizontal support 420 configured in the horizontal direction of the lower support 400. In this case, the first height adjustment screw 421 may be coupled with the second height adjustment screw 422 configured in a form that has a frictional force such that the coupling assembly is closely attached to a lower surface of an object. Referring to the left side view and the right side view of the lower support 400, the first height adjustment screw 421 and the second height adjustment screw 422 may be each configured in multiple pieces, as illustrated in C and D of FIG. 9. Also, a region of the second height adjustment screw 422 which comes into contact with a lower surface of an object may be configured in a shape of the second height adjustment screw head 423 having a greater surface area to maximize frictional force.

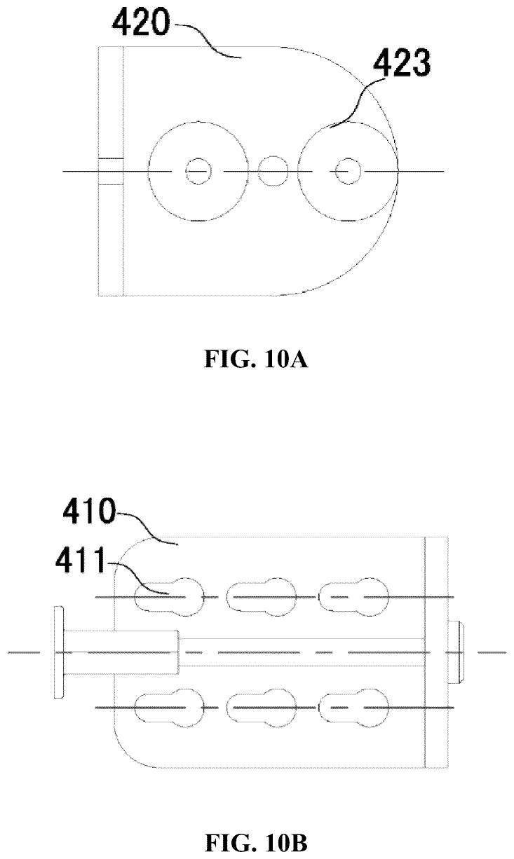

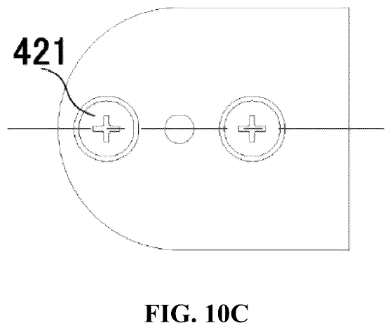

A to C of FIG. 10 respectively illustrate a plan view, a front view, and a bottom view of the lower support 400. Referring to the plan view of the lower support 400, multiple second height adjustment screws 422 may be in the lower support 400 as illustrated in A of FIG. 10, and the descriptions made with reference to FIG. 9 may be used for descriptions of the front view. Referring to the bottom view of the lower support 400, multiple first height adjustment screws 421 may be in the lower support 400 as illustrated in C of FIG. 7.

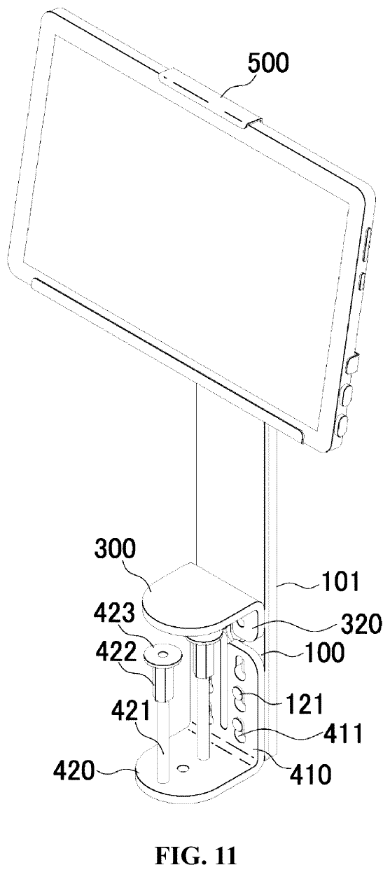

FIG. 11 is a view illustrating an embodiment of a display stand, which may be charged using a pogo pin coupling, according to an embodiment of the present disclosure;

Referring to FIG. 11, the mounting device 10 having a double screw structure may adjust first heights of the upper horizontal support 310 and the lower horizontal support 420 through a configuration in which the display mounting module 500 is coupled with the display coupling unit 111 and the projection 120 of the sliding body 100 is coupled with the groove 411 of the lower support 400. In addition, second heights of the upper horizontal support 310 and the lower horizontal support 420 may be adjusted by the first height adjustment screw 421. In addition, third heights of the upper horizontal support 310 and the lower horizontal support 420 may be adjusted by the second height adjustment screw 422.

FIG. 12 is a view illustrating a battery holder of a display stand, which may be charged using a pogo pin coupling, according to an embodiment of the present disclosure.

Referring to FIG. 12, a battery holder 600 has a space to which a battery may be coupled, and may be configured in a form in which an upper surface and side surfaces facing each other are open. In addition, the battery holder 600 may include a battery that supplies power to a display and a card reader.

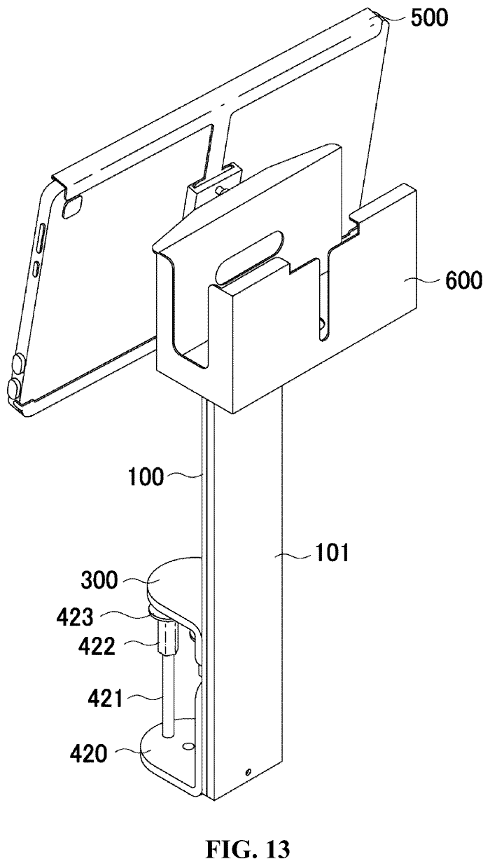

FIG. 13 is a view illustrating an embodiment in which a battery holder 600 is applied to a display stand, which may be charged using a pogo pin coupling, according to an embodiment of the present disclosure.

Referring to FIG. 13, the battery holder 600 of the present disclosure may be attached to the rear of a slide body. Although not illustrated in the drawings, the battery holder 600 of the present disclosure may be attached to a lower surface of the lower support 400.

The present disclosure may easily detach a display from a display stand by supplying power in a pogo pin manner.

Also, the present disclosure may prevent the heat generated by supplying the power during wireless charging from being transferred to a display by applying a heat sink to a display stand module.

Also, the present disclosure may apply a mounting device to tables having various thicknesses by adjusting a width of a fixing module through a double screw structure.

Also, the present disclosure may prevent a cable, through which power is supplied or signals are communicated, from being exposed to the outside by installing a sliding cover.

Those skilled in the art to which the present disclosure belongs will understand that the present disclosure may be easily modified into another specific form based on the descriptions given above without changing the technical idea or essential features of the present disclosure. Therefore, the embodiments described above should be understood as illustrative in all respects and not limiting. The scope of the present disclosure is indicated by the claims described below, and all changes or modified forms derived from the meaning, scope of the claims, and their equivalent concepts should be interpreted as being included in the scope of the present disclosure. The scope of the present application is indicated by the claims described below rather than the detailed description above, and all changes or modified forms derived from the meaning, scope of the claims, and their equivalent concepts should be interpreted as being included in the scope of the present application.

What is claimed is:

1. A display stand capable of being charged using a pogo pin coupling, the display stand comprising:
a sliding body having a planar shape in a longitudinal direction;
a battery holder coupled to a preset position of the sliding body, having a hexahedral shape including an upper surface and open two faces facing each other, and including a space which corresponds to a size of a battery and in which a battery is mounted;
a mounting bracket including a display coupling unit installed at one end of the sliding body and configured to rotate right and left by a preset angle;
a display mounting module coupled to the display coupling unit in a sliding manner and having a display mounted on the display mounting module; and
a coupling assembly including an upper support and a lower support at another end of the sliding body such that the display stand is mounted on an object,
wherein a coupling height is adjusted through a double screw structure of the lower support.

2. The display stand of claim 1, wherein
the battery holder uses at least one of wireless charging and wired charging.

3. The display stand of claim 1, wherein
multiple protrusions are formed on the sliding body, and
protrusion heads, each having a greater area than each of the multiple protrusions, are formed respectively at ends of the multiple protrusions.

4. The display stand of claim 1, wherein
a card reader coupling unit configured to be coupled to a card reader by being adjacent to the mounting bracket on the sliding body.

5. The display stand of claim 4, wherein
the battery holder supplies power to the display and the card reader.

6. The display stand of claim 1, wherein
the sliding body further includes a sliding cover that slides in the longitudinal direction to open and close,
an internal space through which a cable passes is formed between the sliding body and the sliding cover, and
the cable passing through the internal space is not exposed to an outside.

7. The display stand of claim 6, wherein
multiple cable inlets are formed in the sliding body, and
the cable passes through an upper cable inlet formed in an upper portion of the sliding body, a lower cable inlet formed on a lower portion of the sliding body, and a space between the sliding body and the sliding cover, and supplies power to one of the battery and the display.

8. The display stand of claim 1, wherein
the sliding body further includes a rotation cover in which multiple hinges are formed in the longitudinal direction and which is opened and closed by rotating in a direction of the multipole hinges.

9. The display stand of claim 1, wherein
the display mounting module includes a charging port for receiving power from an outside.

10. The display stand of claim 1, wherein
the coupling assembly adjusts a coupling height through coupling positions of multiple protrusions formed on the sliding body and multiple grooves formed on the lower support.

11. The display stand of claim 2, wherein
the battery holder is coupled to a lower end of the lower support.

12. The display stand of claim 1, wherein
the display holder module includes the wireless charging module, and includes a heat sink between the display and the wireless charging module, and
the heat sink prevents heat, which is generated during wireless charging, from being transferred into the display.

13. The display stand of claim 1, wherein
the display mounting module and the display coupling unit respectively include a male pogo pin and a female pogo pin.
